(19) United States
(12) Patent Application Publication
(10) Pub. No.: US 2013/0212618 A1
(43) Pub. Date: Aug. 15, 2013

(54) INDIVIDUALIZED PROGRAM GUIDE BASED ON SYSTEM AND USER CONSTRAINTS

(71) Applicant: Mark Alan Schultz, Carmel, IN (US)

(72) Inventor: Mark Alan Schultz, Carmel, IN (US)

(21) Appl. No.: 13/881,099

(22) PCT Filed: Nov. 10, 2010
(86) PCT No.: PCT/US10/02948

§ 371 Date: Apr. 23, 2013

(51) Int. Cl. H04N 21/482

(52) U.S. Cl. CPC H04N 21/482
USPC 725/30; 725/25

(57) ABSTRACT

Control of access to video content is achieved by filtering information identifying the available video content according to one or more applicable profiles and then delivering to an authorized user only the filtered results for the information in a form such as an electronic program guide. In this way the filtered results in the exemplary electronic program guide represent only the content items that meet the profile criteria. Content information, which fails to meet the filtering criteria, can be blocked or scrambled or deleted from the exemplary electronic program guide as a further constraint prior to delivery of the filtered set of information to the authorized user.

### CROSS-REFERENCE TO RELATED APPLICATION

The present application for patent is related to U.S. Patent Application Attorney Docket No. PU 100112 and entitled “Gateway Remote Control System and Method of Operation”. The teachings of the above-identified patent application are expressly incorporated herein by reference.

### TECHNICAL FIELD

The present invention relates generally to video display technology and graphical user interfaces and, more particularly, to the generation and usage of program guides for individuals based on system and user constraints.

### BACKGROUND OF THE INVENTION

Conventional program guides such as those distributed in print media and those furnished by cable TV providers generally include a program listing table arranged by channel chronologically. The electronic program guides (EPG) furnished by content providers are also interactive in that individual program listings can be selected for viewing or recording or even for generating an on-screen reminder when the selected program is about to air. Many simple EPGs even allow the user to sort the numerous program listings by date or by title or by theme.

More recently, with the growth and penetration of digital video recording devices (DVRs) and personal video recording devices (PVRs) in the consumer marketplace, the adaptability of electronic program guides has continued to increase. It now appears to be feasible to highlight individual programs in a program listing as those programs that are, or should be, of interest to the user on the basis of either a user-provided profile or a default profile. One example of such a system is described in an article by B. Smyth et al. entitled “Personalized Electronic Program Guide for Digital TV”, AI Magazine, Vol. 22, No. 2, pp. 89-98 (Summer 2001). Multi-user profiles are also used to sift through the program guides in order to satisfy the specifically profiled interests of each user or group of users.

Yet while the electronic program guide can be subjected to sorting and profiling according to the user's interests, the enormous amounts of information in the unabridged program guides are still available to all users. No techniques are known that are capable of controlling the furnished program guide information to include only programming and programming information which conforms to one or more stored profiles.

### SUMMARY OF THE INVENTION

Embodiments of the present invention are directed at least in part to resolving the deficiencies of the prior art by providing a method and system for individualizing program guide information in accordance with user and/or system constraints.

In one embodiment of the present invention a method for controlling access to content includes receiving a user request for electronic program guide information, wherein the user request identifies a user associated with the request, comparing the user identification with at least one stored profile for at least one of the user and a system used to send the request, filtering the electronic program guide information using at least one of the at least one user profile and the system profile to generate a filtered set of electronic program guide information and blocking access to content associated with the electronic program guide information that is not included in the filtered set.

In an alternate embodiment of the present invention, a system for controlling access to content includes at least one content source for providing content and a gateway for receiving a user request for electronic program guide information, wherein the user request identifies a user associated with the request, comparing the user identification with at least one stored profile for at least one of the user and a system used to send the request, filtering the electronic program guide information using at least one of the at least one user profile and the system profile to generate a filtered set of electronic program guide information, and blocking access to content associated with the electronic program guide information that is not included in the filtered set. The system can further include at least one playout device for rendering received content.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a gateway system and a portion of the information data flow therein in accordance with an embodiment of the present invention;

FIG. 2 depicts a diagram of data flow of an exemplary filtered user guide information from the gateway toward various users in accordance with an embodiment of the present invention;

FIG. 3 depicts a high level block diagram of system elements and information data flow involved in performing a user search operation in accordance with an embodiment of the present invention;

FIG. 4 depicts a high level block diagram of a gateway in communication with a set top box (STB) capable of adapting to changing accessibility parameters or constraints in accordance with an embodiment of the present invention; and

FIG. 5 depicts a flow diagram of a method for individualizing program guides in accordance with system/user constraints in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION

Embodiments of the present invention advantageously provide a method and system for individualizing program guide information in accordance with user and/or system constraints. Although the present invention will be described primarily within the context of an electronic program guide, the specific embodiments of the present invention should not be treated as limiting the scope of the invention. It will be appreciated by those skilled in the art and informed by the teachings of the present invention that the concepts of the present invention can be applied to substantially any network for the control and distribution of content.

In the description below, every attempt is made to use terminology in a consistent manner. It will be understood that the terms of “program guide”, “electronic program guide”, and “EPG” are intended to pertain equally to the same content information without limitation or modification of the intended scope, unless expressly stated.

Control of user access to video content is realized by filtering information related to the content according to one or more applicable user based and/or system based profiles and then delivering to an authorized user only the limited set of filtered results for the information for viewing. In various embodiments, the results can be viewed in a form such as an electronic program guide. In this way, the filtered results in the exemplary electronic program guide represent only those content items that meet the system and user criteria for viewing by the authorized user. In one embodiment of the present invention, no other information from the program guide regarding the content, other than the content items that meet the system and user criteria for viewing, is presented in any useable form to the user.

For example, in one embodiment of the present invention, content information, which is in the electronic program guide prior to filtering and which fails to meet the filtering criteria, is blocked or scrambled or deleted from the program guide prior to delivery to the authorized user. Viewing of content is then enabled by selecting only from the filtered results presented to the authorized user. Content and its related information in the program guide that does not meet the filtering criteria is not available for selection in the exemplary program guide since it is not present in a useful viewable and selectable form in the filtered set of information. In one embodiment of the present invention, filtering criteria is separated into user based criteria and system based criteria. The user based filtering criteria can include user identification, time slots, dates or days, channels, specific programs, content ratings, locations for viewing, parental control information, and the like. System based filtering criteria can include configuration information for the home network, viewing device location and the like. In a broader application of these concepts, filtering criteria can also include: media identification including any descriptive information for media such as music, software applications, literature, and the like; electronic addresses such as IP or URL addresses for websites and services offered thereon; identification and descriptive information for interactive Internet applications including web games and the like; download information for software and content downloads; and telephone number information including the entire phone number, address, and name associated with the number.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

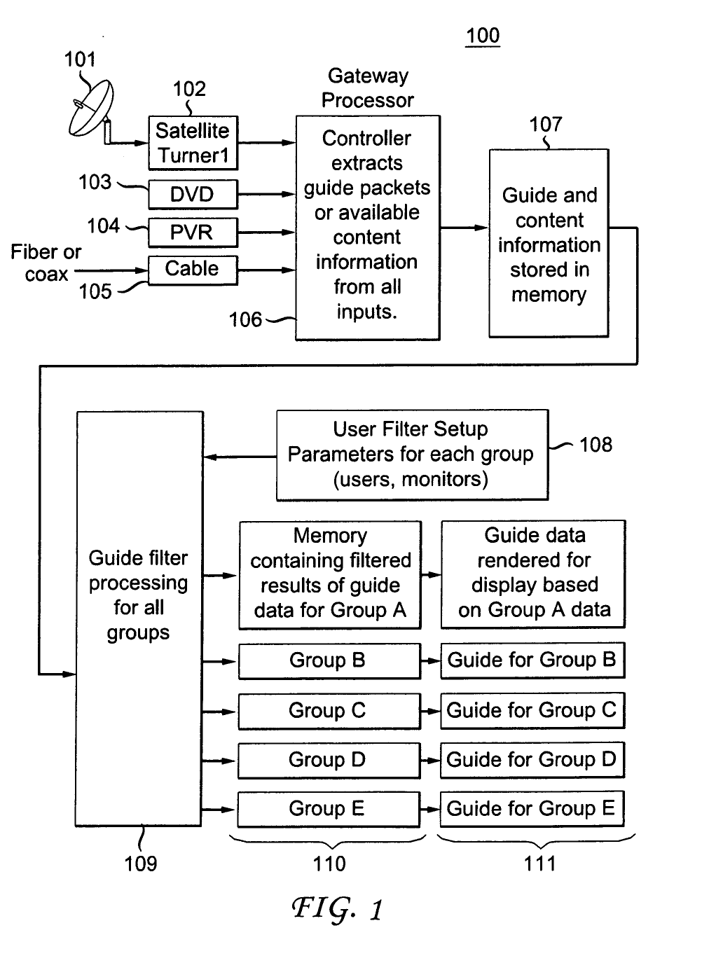

FIG. 1 depicts an exemplary home entertainment network realized in accordance with an embodiment of the present invention. The elements of the home entertainment network 100 of FIG. 1 illlustratively include: a receiving antenna 101, a satellite tuner 102, a DVD player 103, a PVR 104, a cable TV device 105, a residential gateway 106, a guide and content information storage means 107, a profile storage means 108, a guide filter 109, a filtered results storage means 110, and a display 111. Background information about the basic functionality of many of these devices can be found in the Smyth article cited above and in U.S. Patent Application Publication Nos. 2007/0136752 to Sanders and 2009/0187845 to Beck and in U.S. Pat. No. 6,721,954 to Nickum, all of which are incorporated herein by reference in their entirety.

The cable device 105 can be realized in an exemplary embodiment as an xDSL device, a wireless service connection, or simply a cable connection (i.e., point of presence). Other similar realizations are understood by persons skilled in this art area. It should be understood that storage means 107, 108, and 110 together with filter 109 can be implemented in one embodiment as integrated within the gateway 106 or as being a separate storage means outside of the gateway 106. In addition, although in the embodiment of FIG. 1, the storage means 107, 108 and 110 are depicted as separate components for ease of explanation, in alternate embodiments of the present invention, storage means 107, 108, and 110 can comprise a single storage means. Even further, the display 111 of FIG. 1 should be understood as being either a display device for which the stored guide data is intended and for displaying content or, in alternate embodiments of the present invention, a communications path to a display device over which the stored, filtered program guide information is transmitted for subsequent display. It is intended that any reference to a display device also includes a set top box or computer processor or other processing element combined communicatively with a monitor or display or television receiver or the like.

In the embodiment of FIG. 1, the gateway 106 is positioned as a central point in the home entertainment network between input devices and output devices. The gateway functions as a gatekeeper in the information flow between the input devices and the output devices. In this way, the gateway 106 controls user access to content. Exemplary input devices, such as devices 101-105, in the exemplary network of FIG. 1 provide content as well as content information such as electronic program guide information and the like. Typically, electronic program guide information and the associated content are available from the satellite and cable content providers, whereas content and some related content information, perhaps in the form of associated metadata, are provided by the DVD 103 and PVR 104. Output devices are generally understood to encompass devices which receive and display the content and content information. The output devices can include such exemplary devices as set top box and display device combinations, stand alone monitors or television receivers, and computer and monitor combinations. Other display elements can be utilized for realization of the network in FIG. 1.

In the embodiment of FIG. 1, the residential gateway 106 receives content and content related information from one or more of the input devices. The content related information describes available content and is presented in a particular format such as an electronic program guide or the like. Many formats are possible for the content related information. Obviously, one format is the well-established table format. Other formats are presented in on-line video guides such as the one from the TV Guide website, guides and listings from third party media providers such as Netflix, formats or direct links or shortcut links to media files, directory listings in applications such as iTunes from Apple Computer, and computer listings or directories for media copied to, and stored in, a computer connected to the home entertainment network.

The gateway 106 extracts the content information from all the input devices as it is received. Content information from the DVD 103 and PVR 104 is suitable for formatting by the gateway 106 into an electronic program guide format. In order to simplify the remaining description of the inventive techniques, the description below will focus on one particular type of content information, namely, electronic program guide information. It will be appreciated that this approach is not intended for purposes of limitation, but rather for purposes of simplified explanation.

In the embodiment of FIG. 1, the electronic program guide and the related content information are stored in the storage device 107. As previously mentioned, the storage device 107 can be realized as internal storage for the gateway 106 or external storage for the gateway 106. The storage device is intended to encompass any type of memory having sufficient size and operational speed to satisfy the needs for the gateway with respect to the electronic program guide and the related content information.

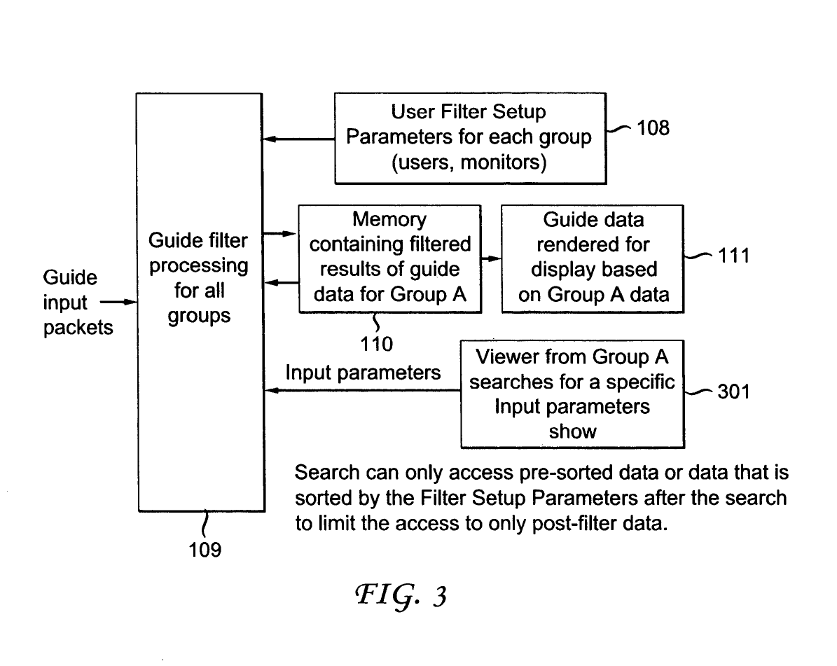

Although not shown in FIG. 1, a communication path similar to that shown, in part, in FIG. 3 is established between the user and the gateway. The user initiates the interaction with the gateway by, in one embodiment, turning on a display device or by making a request for content or guide information via a displayed menu or the like. Such a communication can also involve a request for access to the system. In general, a user's request for access includes an identification of the particular user.

In one embodiment of the present invention, when such a request is received by the gateway, the user request can initiate an authentication procedure in the gateway. In accordance with the present invention, the authentication can be as simple as have the user provide user identification with the gateway checking the authenticity of that identification or, alternatively, it can be as rigorous as requiring an identification and a password, which are both associated with the user identification. Once the gateway determines the authenticity of the user by verifying the provided identification and password, such as by comparison to previously stored copies of the same information, the user is granted access to the system. The user identification and the password for use by the gateway can be stored, for example, in a user profile storage means 108, which will be discussed in more detail below. Many authentication procedures, which are initiated by a user request, are well known in the art and will not be explained further herein.

As mentioned above, user profiles are stored in profile storage means 108. Each user profile is associated with a particular system user or a group of such users. A user profile includes an identification of the user or the user group as well as authentication information such as a password, where required. In various embodiments of the present invention, the user profile can also include other personal information about the user such as age; viewing rights such as a restriction on allowable program rating, allowable program genre, allowable broadcast channels, for example; viewing preferences; time limits for viewing in terms of a maximum amount of viewing time within a certain time period such as a day or week, for example; time periods for viewing such as from 3-6 PM on weekdays and from 12-10 PM on weekends, for example; and other related parameters. User profiles are typically generated by the user or user group. In various embodiments, such as for minor children, a user profile may be generated by a parent or guardian or an authorized proxy. In alternate embodiments, portions of a user profile can be generated by the gateway or system. For example, default profiles can be made available to, or initially established for, each user and user group. It should be noted that throughout the description of the invention, herein, user profiles are also referred to as setup information.

In accordance with the present invention, system profiles are also stored in the profile storage means 108. The system profiles can be separate profiles associated with each output device such as set top boxes and the like in the home entertainment network or can include a single comprehensive profile that includes entries related to each output device. Default profiles can be used to initialize the system and, at times, to establish a known baseline of information to be displayed in the filtered listing for a new or existing user. In accordance with the present invention, system profiles can be initialized and modified at any time by an authorized person such as a system administrator.

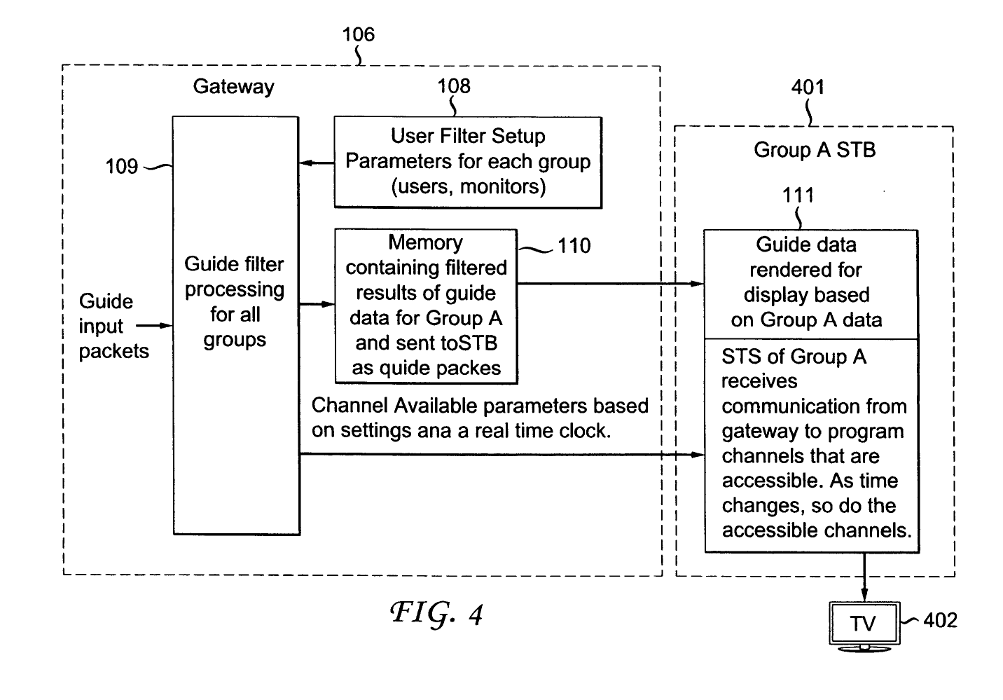

In various embodiments of the present invention, a system profile can also identify an associated output display device when the profiled system device is connected to a display and is not itself a display. For example, a system profile will usually identify the output device and possibly its location on the premises. Other information contained in a system profile can be similar to the information found in the user profile including: viewing rights on the output device such as a restriction on allowable program rating, allowable program genre, allowable broadcast channels, and the like; time limits for viewing on the output device in terms of a maximum amount of viewing time within a certain time period; time periods for viewing on the output device; information about the display device and its capabilities; information about the set top box (STB) associated with the display (see FIG. 4), when an STB is used; and other related parameters including device parameters. Some information about the STB can also include its location and purpose with respect to each viewing user. An STB can provide access to the Internet, phone services, home intercom system, home monitoring and security systems, interactive games both inside and outside of the home, wireless web access, and possibly access to remote wireless video transmitters. A gateway is capable of controlling each STB for each of these purposes based on an associated profile.

In one exemplary embodiment of a system profile of the present invention, a profile of an STB in a common area family room would contain few restrictions when the family is all home because, in most cases, adults can monitor the viewing content of children in the family room, whereas a profile of an STB in a child's bedroom would contain much more restrictions since viewing may not be as closely monitored in that personal space.

In accordance with the embodiment of FIG. 1, the filtering of electronic program guide information supplied by the content providers and input devices and arranged by the gateway is performed by the filter 109. Inputs to the filter 109 can include the electronic program guide information and the user and system profiles. As such, in one embodiment the filtering is based on both user and system profile criteria to generate a more limited and filtered set of results from the electronic program guide information for the user. The filtered set of results is understood to meet the criteria set in both the user profile and the system profile that correspond to the user identification and output device identification, respectively.

The filtering of the present invention can be accomplished in response to a request for access by an authorized user or group of users on an authorized display device in the home entertainment network. In such an embodiment, the associated user and system profiles are input to filter 109 along with the guide information in order to generate the particular filtered set of results for the identified user (or user group) and display device. The filtered results can be transmitted directly to the authorized display device (including its associated STB) for rendering and viewing by the identified user on the associated display device(s).

In an alternate embodiment of the present invention, filtering can be accomplished for some or all users and groups of users by using an “off line” mode such as when the gateway is initializing the system or at some regularly scheduled time without any requirement for a pending user request. In this mode of operation, filtering is incomplete until a particular output device, being accessed by a user or user group, is identified to the gateway and the associated system profile is used to filter the electronic program guide information. If the filtered set of results has been previously stored for a user or user group, then the filter applies the system profile to the stored filtered set of results for the particular user or user group to produce a final useable filtered set of results that can be rendered for the user or user group on the particular display device. Of course, the electronic program guide information can be filtered for all possible, or those most likely, combinations of users and display devices, wherein the filtered sets of results are stored in the storage device 110 and indexed for quick and easy recall by the system when a user request is received in the network. That is, a filtered set of program guide information can be recalled from storage 110 for an identified authorized display device or user for which it was previously stored.

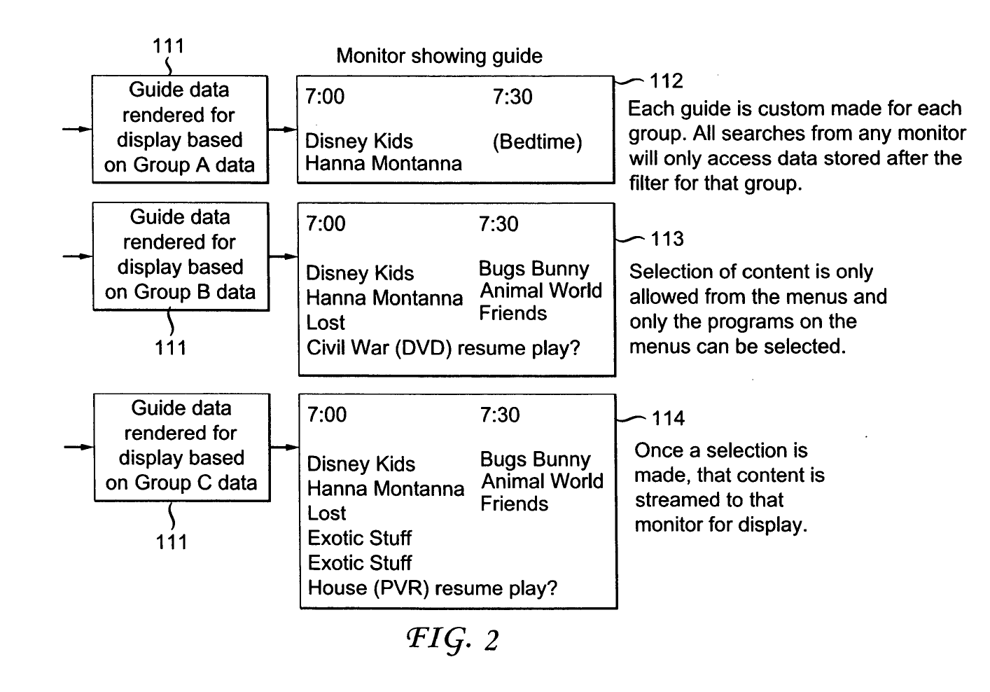

The combination of FIGS. 1 and 2 depict an example of the transmission of guide data 111 (i.e., program guide information) to display monitors 112-114. The display monitors can each be controlled by an associated STB (not shown) interposed between the guide data 111 and the related monitor. For example, FIG. 2, depicts a diagram of data flow of an exemplary filtered user guide information from the gateway toward various users in accordance with an embodiment of the present invention. In FIG. 2, the exemplary filtered set of electronic program guide information related to user group A and the display device 112 is depicted on the screen of the display device 112. A more filtered exemplary set of electronic program guide information related to user group B and the display device 113 is depicted on the screen of display device 113. In addition, an even more filtered set of electronic program guide information related to user group C and the display device 114 is depicted on the screen of the display device 114. The sets of data related to user groups B and C include program guide information input from the satellite TV and/or cable TV content providers and also from the input devices such as the DVD and PVR.

As shown in the embodiment of FIG. 2, each filtered set of electronic program guide information can be formatted in the same manner as, and with the same or similar properties to, the original EPGs supplied by the content providers. This format appears generally as a typical tabular form to show program listings versus time and additional space in the format can be used to show content listings related to other features such as search results for individual show times and content available from other input devices such as the DVD and PVR. Of course, this additional information would still be required to meet the relevant user and system based filtering criteria.

FIG. 2 depicts an example of how each STB and associated display may differ with respect to filtered guide information as rendered and as based on the profile parameters utilized by the gateway filtering. Each display location can access and then resume a previously watched content stream that was not completed because the user can be identified with an identification, as described above, and because the filtered set of program guide information accumulated by the gateway can include individual content tracked and streamed to particular STBs. For example, user group A and user group B could be accessing and viewing the same content but at different locations in the content and on displays in a different room from the original room of display since the gateway can track and control all available content on the network. As depicted in FIG. 2, the available choices rendered on the display for each user are only those elements from the electronic program guide information that meet the criteria defined in both the user's profile and the system profile, at least as it relates to the display device identified by the user. The totality of a large electronic program guide is filtered to a generally smaller set of filtered results. It is this set of results from which the user is allowed to select a program for viewing or recording. If a program does not meet the filtering criteria defined in the user and system profiles, then it is not present in a legible or selectable form in the filtered list that is rendered on the display for that user. That is, in various embodiments of the present invention, the guide information that is not included in the filtered set of information can be deleted or scrambled so that it is unintelligible to a viewer.

In accordance with the concepts of the present invention, the filtered set of electronic program guide information becomes the means for controlling access to content. As previously described, filtering is performed based on user and system profiles that assist in limiting, a priori, the amount, types, times, and system viewing locations of content for a particular authorized user.

For example, for purposes of explanation, it can be assumed that a child is attempting to access the content through an STB that is located in a room identified as a child's room. The associated STB is restricted in the system profile to show programs that bear less than a PG-13 rating. The child's user profile can contain defining parameters such as: age 10; male; no programs rated at or above PG-13; a maximum of 3 hours of viewing per day; educational content viewing permitted from 3-7 PM on school days; and viewing of Hannah Montana can only occur from 3-4 PM each day. The filtered set of program guide information rendered for, and presented to, this user, when the user is authorized on the display will be generated to only show program listings less than PG-13, only educational programs from 3-7 PM during the week, and also Hannah Montana only from 3-4 PM each day. All content viewing selections for this child are then controlled to be accessed from the filtered program guide presented to the child. The gateway via the filtered set of program guide information limits the access to all programs and acts as the controlling device to the household on a per individual or per monitor basis as described above.

For another example, it is assumed that a user has been granted access by the gateway to content on a specific channel as selected. It is further assumed that the specific channel is not available and not authorized for viewing during the next one hour time slot, by virtue of a parameter related to the channel in one of the user profile and the system profile. In accordance with aspects of various embodiments of the present invention, the gateway initiates one of the following actions during that next one hour time slot when the channel is not authorized for viewing: the gateway can cause the STB at the user's display to turn off; the gateway can cause a message to be displayed on the user's display informing the user that content on the selected channel is not available during this time slot; or the gateway can cause the STB to switch channels to a program that is authorized for that time slot.

Exemplary communicative coupling required for such data flow and control between the gateway and an STB 401 with associated TV receiver 402 is shown in FIG. 4. Connections between the gateway and STBs in conformance to standards set by the Media over Coax Alliance (MoCA) can provide a sufficient platform for such backbone communications and device control in the home entertainment network.

Filtering leads to a controlled access solution in which only programs displayed on the filtered set of the guide can be selected. All other content is locally blocked from viewing by deletion or scrambling. The filtered set of program guide information for a user is the only information presented to that user for selection of viewable content. If a program does not appear in the particular filtered set of information, then it did not meet the criteria input to the user and system profile based filter. When the user makes a selection of particular content in the filtered set, the gateway receives the user selection and transmits the content, perhaps by streaming it, to the authorized user on the identified display.

FIG. 3 depicts a high level block diagram of system elements and information data flow involved in performing a user search operation in accordance with an embodiment of the present invention. That is, FIG. 3 shows an example of the home entertainment network being used by a viewer to conduct a search for specific content. The search is initiated by the user 301 through some user input device in communication with the gateway. The user input device can be realized as a remote control device, a computer, a PDA, a keyboard, or even an on-screen search menu displayed for the authorized user on the associated display upon a user's menu selection to enter a search mode. The search parameters from the user can cover a wide variety of areas from program titles to program themes and the like. Filter 109 in conjunction with the gateway receives the user's input search parameters. The filter then either recalls a stored filtered set of information for that user and the user's display or the filter initiates a new filtering operation of the full set of guide information and the relevant system and user profiles. The user's search parameters are applied by the filter to locate any program occurrences that meet the search criteria as well as the other filtering criteria determined by the profiles. The filtered set of program guide information resulting from the search is always based on the profiles used for that particular user or user group subject then to the search parameters. Access to program content that meets the search criteria but is outside the profile criteria would not appear in the filtered set that is returned to the user display for rendering. Similarly, access to program content that meets the search criteria but is outside the profile criteria with respect to a particular time requirement would be temporarily blocked from the filtered set being displayed until the time requirement is satisfied.

For example, if an authorized user wishes to check when the program Lost is showing, a broad search of the EPG information will be initiated. Listings for the program will only show up if they appear in the post-filter set of program guide information. Moreover, viewing times for the program would only be those showings that meet the system and user profile based filter criteria. All other listings for the program would be blocked from viewing and access for the authorized user at the particular display.

FIG. 4 depicts a high level block diagram of a gateway in communication with a set top box (STB) capable of adapting to changing accessibility parameters or constraints in accordance with an embodiment of the present invention. That is, FIG. 4 shows how new or changing parameters such as profile criteria can be downloaded from the gateway 106 to an individual STB in accordance with an embodiment of the present invention. More specifically, system and user profile information can be downloaded from the gateway directly into an STB to control the access to channels at a particular moment in time by editing program guide information in accordance with the concepts of the present invention. As the parameters change over time, the gateway can track and modify parental control information on any one STB without requiring the parents to reprogram each STB individually. The centralized control of these features by the gateway in conjunction with system and user profiles simplifies the control and programming of the devices located downstream from the gateway in the home entertainment network.

In accordance with the concepts of the various embodiments of the present invention described herein, a playout device controller, such as an STB, limits user access to content by editing a program guide and not based on what is available at the STB input terminals from the directly connected content sources (i.e., cable or wide bandwidth distribution).

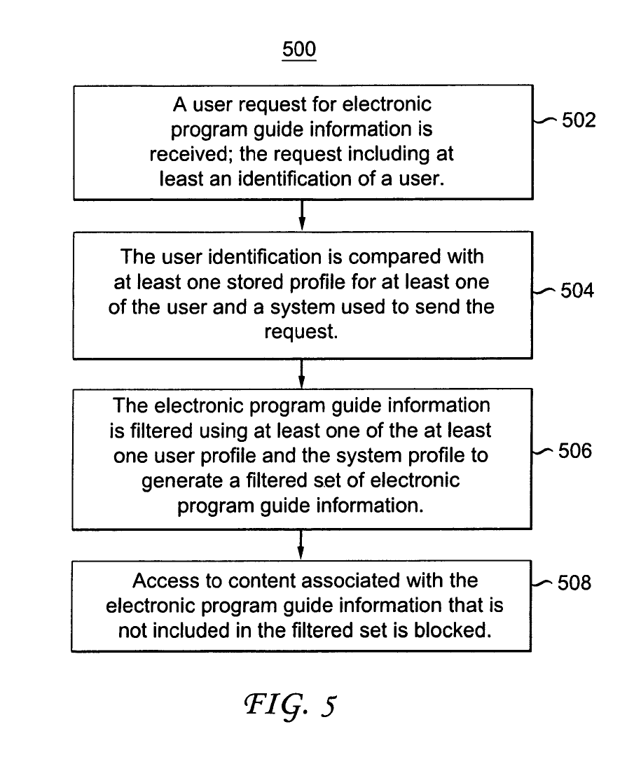

FIG. 5 depicts a flow diagram of a method for individualizing program guides in accordance with system/user constraints in accordance with an embodiment of the present invention. The method 500 begins at step 502 during which a user request for electronic program guide information is received, where the user request identifies a user associated with the request. The method 500 then proceeds to step 504.

At step 504, the user identification is compared with at least one stored profile for at least one of the user and a system used to send the request. The method then proceeds to step 506.

At step 506, the electronic program guide information is filtered using at least one of the at least one user profile and the system profile to generate a filtered set of electronic program guide information. The method 500 then proceeds to step 508.

At step 508, access to content associated with the electronic program guide information that is not included in the filtered set is blocked. The method 500 can then be exited.

Having described various embodiments for a method and apparatus for a method and system for individualizing program guides in accordance with user and/or system constraints, in for example, a home entertainment network (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for controlling access to content, the method comprising:
receiving a user request for electronic program guide information, wherein the user request identifies a user associated with the request;
comparing the user identification with at least one stored profile for at least one of the user and a system used to send the request;
filtering the electronic program guide information using at least one of the at least one user profile and the system profile to generate a filtered set of electronic program guide information; and
blocking access to content associated with the electronic program guide information that is not included in the filtered set.

2. The method of claim 1, further comprising:
communicating said filtered set of electronic program guide information to a display device identified in said user request.

3. The method of claim 1, wherein the method further comprises authenticating the identification of the user.

4. The method of claim 1, wherein the method further comprises storing a profile for each user and for each playout device.

5. The method of claim 4, wherein a system profile includes location information for a display device for viewing content.

6. The method of claim 1, wherein said blocking includes scrambling electronic program guide information that is not included in the filtered set so that it becomes unintelligible to the user.

7. The method of claim 1, wherein said blocking includes deleting electronic program guide information that is not included in the filtered set to remove it from the electronic program guide information.

8. The method of claim 1, wherein said user profile includes at least one of an identification of the user, authentication information including a password, personal information of the user including age, viewing rights for the user, the viewing rights being related to at least one of allowable program rating, allowable program genre and allowable broadcast channels, viewing preferences for the user and time limits for viewing by the user in terms of a maximum amount of viewing time within a certain time period.

9. The method of claim 1, where said user request is denied in the event of a failure in generating a filtered set of electronic program guide information.

10. The method of claim 1, wherein the user request includes a search parameter for identifying content related to the search parameter, wherein the filtering further comprises filtering the electronic program guide information using the search parameter to generate the filtered set of electronic program guide information.

11. The method of claim 1, wherein, in the event of a failure in generating a filtered set of electronic program guide information, a message is communicated to the user via an associated display informing the user that the electronic program guide information is not available.

12. A system for controlling access to content, comprising:
at least one content source for providing content;
a gateway for:
receiving a user request for electronic program guide information, wherein the user request identifies a user associated with the request;
comparing the user identification with at least one stored profile for at least one of the user and a system used to send the request;
filtering the electronic program guide information using at least one of the at least one user profile and the system profile to generate a filtered set of electronic program guide information; and
blocking access to content associated with the electronic program guide information that is not included in the filtered set; and
at least one playout device for rendering received content.

13. The system of claim 12, wherein said content source comprises at least one of a source of satellite content, a DVD player, a source of cable content, a personal video recorder and the internet.

14. The system of claim 12, wherein said playout device comprises a television set.

15. The system of claim 12, wherein said playout device comprises a computer.

16. The system of claim 12, further comprising a storage means for storing at least one of the user profile, the system profile and the filtered electronic program guide information.
